(19) United States
(12) Patent Application Publication
(10) Pub. No.: US 2025/0015737 A1
(43) Pub. Date: Jan. 9, 2025

(54) METHOD FOR OPERATING AN ELECTROMAGNETIC POWER GENERATOR FOR A WHEEL, AND POWER GENERATOR FOR A WHEEL

(71) Applicant: Ronal AG, Haerkingen (CH)

(72) Inventor: Mike NAGEL, Waghaeusel (DE)

(73) Assignee: Ronal AG, Haerkingen (CH)

(21) Appl. No.: 18/889,013

(22) Filed: Sep. 18, 2024

Related U.S. Application Data
(63) Continuation of application No. PCT/EP2023/056925, filed on Mar. 17, 2023.

(30) Foreign Application Priority Data
Mar. 18, 2022 (DE) 10 2022 106 429.8

(51) Int. Cl. H02P 9/10; H02K 7/00; H02P 9/02; H02P 101/45

(52) U.S. Cl. CPC H02P 9/107; H02K 7/006; H02P 9/02; H02P 2101/45

(57) ABSTRACT

A method for operating an electromagnetic power generator for a wheel and to a power generator for a wheel, in particular of a vehicle. The power generator comprises a rotatably mounted stator, which is held in an equilibrium position by virtue of the eccentric mass center of gravity of the stator, and a rotor, which rotates in the stator and is driven by the wheel. In order to realign a stator which is rotating in an undesired manner and is overrunning during a malfunction produced by shocks for example, the stator is supplied with a current.

This nonprovisional application is a continuation of International Application No. PCT/EP2023/056925, which was filed on Mar. 17, 2023, and which claims priority to German Patent Application No. 10 2022 106 429.8, which was filed in Germany on Mar. 18, 2022, and which are both herein incorporated by reference.

### BACKGROUND OF THE INVENTION

### Field of the Invention

The invention relates to a method and to a power generator within the field of generating electrical energy from the rotational movement of a wheel, the rolling motion of which moves an object, wherein the electromagnetic power generator is mounted on a wheel in such a way that when the wheel rotates, a rotor of the power generator rotates relative to the stator thereof and the power generator thereby generates power.

### DESCRIPTION OF THE BACKGROUND ART

An electromagnetic power generator within the context of the invention is an electrical generator, i.e. an electrical machine that, using electromagnetic induction, converts kinetic energy, in this case the kinetic energy (rotational energy) of the wheel or the kinetic energy of the object moved by the wheel, into electrical energy. Such a power generator is also referred to as a dynamo. The mechanical power is usually supplied to the generator in the form of the rotation of a mechanical shaft. In an exemplary first variant, the interior of the generator contains a concentrically mounted arrangement of a stationary stator (also called stator housing) and a rotor (also called an armature) that is rotatable relative to the stator and is driven by the shaft. Typically, the rotor comprises one or more permanent magnets or one or more electromagnets (also called a field coil or excitation winding) for generating a DC magnetic field, and the stator comprises one or more conductor windings. When the rotor is rotated relative to the stationary stator housing, the rotating DC magnetic field of the rotor induces a voltage in the conductor windings of the stator, thus generating electrical power as a result.

Since only the relative rotational movement between the rotor and stator is what matters here, in examples operating in the same way, the stator comprising the conductor windings can also be rotated via the shaft or another drive relative to a stationary rotor which generates a DC magnetic field. In this case, compared to the first variant, the rotor then becomes a stator which has one or more permanent magnets or one or more electromagnets (also called field coil or excitation winding) for generating a DC magnetic field, and the stator becomes a rotor which has one or more conductor windings and is rotated relative to the stator. In both cases, the relative rotational movement between the rotor and stator or the rotating DC magnetic field (of the rotor or stator) induces an electrical voltage in the conductor windings (of the stator or rotor), i.e. generates electrical power.

In a rotating wheel of an object moved via the wheel, in particular in wheels of a motor vehicle that are rotating relative to a vehicle body, for some practical applications the provision of electrical energy in or at the rotating wheel for an electrical consumer is required in order to implement or enable a function that consumes electrical energy. A first example is the power supply to sensors attached in or to the rotating wheel which measure various parameters, such as tire pressure, temperature or rotational speed, or which send signals. Another example is electrical lighting attached to the wheel that is permanently lit, for example for aesthetic reasons, or that is temporarily lit, for example to implement a “coming home” function that illuminates the wheel once the vehicle has stopped when it reaches its destination for a specified time when the vehicle is being exited.

In other applications, a briefly flashing visual display or warning signal is to be realized, for example to indicate different driving modes of the vehicle (such as autonomous or manual driving mode) or to realize a lateral warning light or brake light, to indicate the direction of travel or the engagement of reverse gear or to generate an visual warning signal, for example if the vehicle is in an accident or if the vehicle is an emergency vehicle. Another application can be the power supply to an electrically operated mechanical actuator, which is used, for example, to close the gaps between the spokes of a wheel with covers in order to reduce the air resistance of the wheel and/or to open them during braking in order to cool the brake.

For this purpose it is technically complex and disadvantageous to transfer electrical energy to the rotating wheel from outside the rotating wheel, for example from the vehicle body, for example via cables or sliding contacts. Systems are therefore known in the prior art that provide electrical energy in the hub of a vehicle wheel from an energy storage device without the need for structural changes to the wheel or the wheel cover and that are basically suitable for different wheels. In these systems, the electrical energy is provided by batteries. The disadvantage here is that the system is not maintenance-free because the battery discharges over time, and for this reason the battery will be fully depleted after a certain period of use and need to be replaced in order to continue using the system. This means additional work for the user, a lack of fail-safety and additional requirements regarding the design of such systems.

For such applications, it has therefore been proposed to generate the electrical energy within the wheel itself, specifically via an electromagnetic power generator arranged in the wheel, which obtains the electrical energy from the rotational movement of the wheel when in driving operation. Such systems are more suitable for such applications because they can be largely maintenance-free, for example when the electrical energy generated by the electromagnetic power generator is stored in a rechargeable battery arranged in the wheel.

An electromagnetic power generator arranged in or on the wheel can be realized in different ways. A first variant requires a structural or manufacturing modification of the wheel itself, which is disadvantageous and complex and severely limits possible applications, since corresponding systems or modules can only be used in wheels specially adapted for this purpose. In a second variant, a corresponding system or module is mounted on the wheel as an additional component, for example similarly to a wheel cover, which completely or partially covers the axial end face of a wheel in the radial and circumferential directions. Wheel covers that contain energy-generating modules are described, for example, in the documents DE 202018 000 319 U1 and US 2014/0043839 A1. However, the implementation in the form of a wheel cover also has disadvantages, which arise, for example, from radial inclination or from the fact that the electrical and electronic elements are exposed to external influences. Furthermore, they require additional design effort to fasten them to the wheel and their possible uses on wheels are limited due to fastening requirements and geometric conditions.

DE 20 2018 000 629 U1, which is incorporated herein by reference, discloses an electromagnetic power generator attached to the wheel, which is arranged in the cylindrical cavity of the hub of the wheel and can be used in several different wheels without increased additional design and manufacturing effort and costs. A corresponding module having such a power generator can easily be adapted to a specific wheel, i.e. a specific wheel can be retrofitted with a correspondingly adapted module without modification of or without significant modification of the wheel, which involves considerably less effort than adapting wheels. Preferably, the basic structure, the basic constituents and various components of such systems or modules can always be left unchanged, with the exception of the housing which can be easily designed specifically for a particular wheel. A corresponding module can meet practical requirements regarding strength when in motion, protection against water, for example splashed water and moisture, as well as low and high temperatures.

The electromagnetic power generator described in this document corresponds to the second variant described at the outset, with a rotatably mounted stator having an eccentric center of mass in the form of a pendulum having permanent magnets and a rotor having at least one coil. The rotor is rotated indirectly by the wheel, specifically by the wheel hub to which it is connected for conjoint rotation, such that the rotor rotates together with the wheel as the wheel rolls, and the stator is arranged to be freely rotatable relative to the rotor. The stator is not circularly symmetrical but only has a radially extending weight part over a partial circumference, which results in an eccentric arrangement of the center of mass of the stator radially outside the axis of rotation of the stator. An electrical circuit having an energy control system and a rechargeable battery is connected to the rotor for conjoint rotation, the electrical circuit being connected on the one hand to the power generator and on the other hand to the rechargeable battery. The housing of the system consists of two parts and also contains an electrical consumer that is connected to the electrical circuit, to the rechargeable battery and to the power generator.

The advantage of this known power generator arranged in the wheel hub is that the electrical energy is generated in the rotating wheel itself when the object moved by the wheel is in driving operation and is temporarily stored there in a rechargeable battery. The system is therefore maintenance-free and fail-safe, as no batteries need to be replaced. Furthermore, no electrical energy needs to be supplied to the rotating wheel via cables or the like.

In the rest position, i.e. when the power generator is not generating electrical power, the rotatably mounted stator, which is designed as a pendulum, is rotated downward into a rest position by gravity due to its eccentric center of mass, and is held in this position. In generator mode, i.e. when the power generator is generating electrical power, the stator is rotated from this rest position into an operating position until the torque on the stator caused by gravity corresponds to the torque of the power generator on the stator caused by electromagnetic induction. During normal operation, the deflection of the stator from the rest position is in effect static or constant and is determined by the torque of the power generator on the stator caused by electromagnetic induction. During normal operation of the power generator, i.e. in the power-generating generator mode, while the rotor is rotating together with the wheel, the stator does not rotate or overrun but is merely deflected from its rest position into an operating position in which the torque on the stator provided by the eccentric center of mass of the stator corresponds to the torque of the power generator on the stator provided by the generation of power. The stator is held by gravity at a certain deflection angle with respect to the vertical rest position in the deflected operating position in which the stator applies the necessary counter torque for the rotating rotor.

Within the scope of the invention, however, it has been found that when the rolling wheel is in real driving operation, the freely rotatably mounted stator can overrun (runaway, spinning), whereby the stator is no longer held in a certain angular range due to gravity but undesirable and uncontrolled rotation occurs. It has been found that in a motor vehicle wheel, this effect can already occur at a vehicle speed of approximately 60-80 km/h. Overrunning of the stator is usually triggered by an additional acceleration that briefly acts on the stator when in driving operation, for example when driving with great velocity, when braking or accelerating the vehicle, when steering abruptly or when shocks occur, for example when driving over a bump or due to unevenness of the road surface.

The additional acceleration acting on the stator means that it cannot maintain its intended operating position, but is deflected even further. Since the torque of the stator generated by gravity decreases again as the angle continues to increase when the stator is deflected by 90° relative to the vertical rest position, the stator will usually be deflected by more than 180° relative to the rest position, i.e. overruns. Within the scope of the invention, it has further been found that an overrunning stator in motion then, after the additional acceleration has eased off, does not usually return automatically to the operating position in which the torque on the stator due to gravity and the torque on the stator due to induction are in equilibrium, but continues to permanently overrun and rotate until the wheel comes to a standstill or rotates very slowly and the stator has returned to its static rest or operating position.

Such overrunning of the stator has serious disadvantages. When the wheel rotates during regular operation, a relative angular velocity or speed arises between the rotating rotor and the statically deflected stator that is proportional to the velocity of the vehicle rolling together with the wheel. In the event of a fault, i.e. when the stator overruns, this relative angular velocity is abruptly reduced. In the worst case, the rotational speed of the stator when the wheel rotates is equal to the rotational speed of the rotor, i.e. the relative angular velocity or the difference in rotational speed between stator and rotor is reduced to zero. There is then no relative movement between the stator and rotor and due to the lack of electromagnetic induction no power is generated.

If the stator overruns, the power generator can therefore fulfill its basic function as a power supplier only to a limited extent or not at all. Furthermore, the mechanical stress when the stator overruns can cause damage to the power generator. In addition, an overrunning stator creates an imbalance due to its eccentric center of mass, which statically holds it at a certain angle of rotation via gravity in the generator mode, which the driver of the vehicle may feel and possibly be bothered by.

In order to prevent the stator from overrunning, it would be possible to design the stator to be large and heavy so that, due to its greater mass, it can maintain the operating position up to a higher velocity and reacts more slowly and less sensitively to additional accelerations. However, this approach is disadvantageous because a heavier stator increases the weight of the entire module with the power generator and the stator requires more installation space, leaving less installation space for other components, such as the rotor or a rechargeable battery. However, the installation space in the wheel hub is usually very limited due to the design of the wheel and reducing the size of components such as the battery or the rotor would have disadvantages. A heavy stator also has the disadvantage that after it has overrun, it takes much longer than a lighter stator to return to its rest or operating position due to its greater inertia. Furthermore, it has been found within the scope of the invention that in driving operation situations arise in which the stator overruns, regardless of how large and heavy it is, for example in the case of greater road surface unevenness, such as bumps. Overall, increasing the mass of the stator is therefore not a suitable measure to prevent the stator from overrunning.

### SUMMARY OF THE INVENTION

It is therefore an object of the invention to provide a method for operating an electromagnetic power generator comprising a rotatably mounted stator having an eccentric center of mass and a rotor, wherein the power generator can be attached to the wheel of an object movable via the wheel and can preferably be arranged in the cylindrical cavity of the wheel hub, and to provide a corresponding electromagnetic power generator in which it is ensured by suitable means that the basic function of the power generator as a power supplier is guaranteed more effectively during practical application.

In an example, a method is provided for operating an electromagnetic power generator, which comprises a rotatably mounted stator having an eccentric center of mass and a rotor that can rotate relative to the stator, and which can be mounted on a wheel of an object movable via the wheel in such a way that when the wheel rotates, the rotor rotates relative to the stator and the power generator thereby generates power in a generator mode, has the special feature that the method comprises the following steps:

A first step for detecting whether the stator is overrunning, comprising the steps of determining the rotational speed of the wheel and/or rotor, determining the rotational speed difference between the rotor and the stator, comparing the rotational speed determined for the wheel or rotor and the rotational speed difference determined between the rotor and the stator, and deducing whether the stator is overrunning from the fact that the rotational speed determined for the wheel or the rotor deviates by more than a first threshold value, in particular defined by the user, from the rotational speed difference determined between the rotor and the stator and, in the event that the first step detects that the stator is overrunning, a second step to stop the stator from overrunning by supplying power to the rotor in such a way that the stator is thereby accelerated.

The electromagnetic power generator according to the invention, which has a rotatably mounted stator having an eccentric center of mass and a rotor that can rotate relative to the stator, and which can be mounted on a wheel of an object movable via the wheel in such a way that when the wheel rotates, the rotor rotates relative to the stator and the power generator thereby generates power in a generator mode, has the special feature that the power generator comprises: a first detector designed to detect whether the stator is overrunning, a determinator to determine the rotational speed of the wheel and/or of the rotor, a second determinator to determine the rotational speed difference between the rotor and the stator, a comparator for comparing the rotational speed determined for the wheel and/or for the rotor and the rotational speed difference determined between the rotor and the stator, a deductor to deduce whether the stator is overrunning from the fact that the rotational speed determined for the wheel and/or the rotor deviates by more than a first threshold value, in particular a user-defined threshold value, from the rotational speed difference determined between the rotor and the stator, and/or a controller which, in the event that the detector detects that the stator is overrunning, is designed to stop the stator from overrunning by supplying power to the rotor in such a way that the stator is thereby accelerated.

The invention is described without loss of generality on the basis of the determination of rotational speeds n. Of course, it is equivalently possible to determine a corresponding angular velocity ω instead of one or all of the rotational speeds, i.e. to measure it or to calculate it from the associated rotational speed n (ω=2πn). The same applies to speeds that can be determined from the rotational speeds and can be equivalently used instead of the latter.

Within the scope of the invention, it has been recognized that it is neither possible in practice nor significant for real operation to generally prevent the stator from overrunning when the rotating wheel is in driving operation, as was attempted in vain with a very heavy stator, for example, but that the problem is solved by rapidly detecting and effectively stopping the stator from overrunning such that the rotating stator is as it were caught and permanent rotation of the stator is prevented. In this way, although the stator may be permitted to overrun, prolonged or continuous overrunning of the stator is prevented when the rotating wheel is in driving operation. This ensures the basic function of the power generator as a power supplier, which is not significantly impaired in practice by the at most occasional or short-term overrunning of the stator.

The invention is therefore particularly directed at catching the rotatably mounted stator as quickly as possible when it overruns, whereby it is brought back into the static equilibrium state of the operating position as quickly as possible even when the object moved by the wheel is in continuing driving operation and the power generator can generate power. To catch the overrunning stator, the rotor is energized or controlled. As a result, the power generator is preferably switched from generator mode, in which power is generated in the rotor, in particular in conductor windings of the rotor, to a motor mode, in which a rotating electromagnetic field is generated by the rotor, in particular by the conductor windings of the rotor supplied with current, via which the overrunning stator is driven and, by active intervention via the power supply to the rotor, is brought back into an operating position, in particular a stationary operating position, for example into the original operating position prior to overrunning, so that the power generator is then able to generate electrical energy again.

The acceleration of the overrunning stator according to the invention caused by supplying power to the rotor in order to catch the overrunning stator again in an operating position, in particular a static operating position, is thus consequently a negative acceleration, i.e. a braking of the overrunning, rotating stator into a stationary operating position. According to the prior art, catching or resetting the stator in this way has until now required the wheel or vehicle to remain stationary for long enough. With the invention, however, it is possible to detect immediately and reliably that the stator is overrunning in the case of a fault and the stator can be caught automatically during driving operation. The energy generated by the power generator in particular as well as the operation of the vehicle in general are therefore not significantly affected by a stator overrunning either.

In simple terms, the invention relates to a method for operating an electromagnetic power generator for a wheel and to a power generator for a wheel, in particular of a vehicle. The power generator comprises a rotatably mounted stator, which is held in an equilibrium position by its eccentric center of mass, and a rotor rotating in the stator and driven by the wheel. In order to catch an overrunning, undesirably rotating stator in the event of a fault caused, for example, by shocks, it is proposed to supply power to the rotor.

According to an advantageous development, it is proposed that in the second step, the rotor in the motor mode can be supplied with power in such a way that it generates a rotating magnetic field which rotates at the rotational speed determined for the wheel and/or the rotor or the rotational speed difference determined between the rotor and the stator. In this case, the rotating magnetic field of the rotor, which acts as a driving motor force on the stator, accelerates the overrunning stator until the stator no longer overruns. The rotational speed determined for the wheel and/or the rotor is therefore used to apply a rotating electric field at this frequency to the power generator in the motor mode and the resulting mechanical driving force accelerates the overrunning, rotating stator until it comes to a standstill relative to the gravitational field. This process is preferably carried out in a closed control loop, in which the first and second steps are continuously repeated and the frequency with which the rotor is controlled in the motor mode to drive the stator is dynamically controlled by closed-loop control.

The time at which the motor mode switches back to the generator mode can be set in various ways. For example, a check can be made to see whether the stator has regained its target position. For this purpose, according to an example, it is proposed that in the second step, the rotor is supplied with power, in particular in the motor mode, until the rotational speed of the wheel and/or of the rotor deviates by less than a second threshold value, in particular a user-defined second threshold value, from the difference in rotational speed between the rotor and the stator. The second threshold value may be the same as or different from the first threshold value.

The switching-back process can be time-controlled. For this purpose, in the second step, the rotor may be supplied with power for a prespecified amount of time, in particular in the motor mode of the power generator, and the power generator may then be switched back to the generator mode. According to an advantageous development, the prespecified length of time of the motor mode may be selected on the basis of the rotational speed determined for the wheel and/or the rotor and/or the velocity of the object moved by the wheel, and a predefined or programmed characteristic map may be used in which the prespecified length of time of the motor mode of the power generator is established on the basis of the rotational speed of the wheel or of the rotor or the velocity of the object moved by the wheel. This makes it possible, for example, to take empirical values into account or to simplify the control effort.

After the second step in which the rotor is supplied with power, the power generator can be switched to the motor mode, a pause time, in particular defined by the user, can be observed and only after the pause time has elapsed is the power generator switched to the generator mode for generating power and power is drawn from the power generator. During this pause time or waiting time, the stator, which has been caught to stop it from overrunning and has been returned to an operating position, can settle and the power generator as a whole can stabilize itself in this state. During the pause time, the rotor may either not be supplied with power or may be supplied with reduced power, in particular with a lower power than the maximum possible. Preferably, during the pause time, no power is drawn from the power generator, i.e. from the conductor windings of the rotor. The pause time can be fixed, in particular between 0.1 s and 20 s, preferably between 0.2 s and 10 s and particularly preferably between 0.5 s and 5 s. The pause time can also depend on the velocity of the object moved by the wheel or on the rotational speed of the rotor and/or of the wheel and can be deduced therefrom, in particular between 0.5 and 1000, preferably between 10 and 500 and particularly preferably between 20 and 100 times the duration of one revolution of the wheel and/or of the rotor.

The basic structure of the power generator according to the invention can be designed as a synchronous machine or as an asynchronous machine in order to realize switching from the generator mode to the motor mode. A particularly advantageous example is the design as a brushless, electronically commutated direct current motor (brushless DC motor, BL-DC, EC motor). An EC motor is a synchronous motor that can be controlled like a DC motor by converter electronics.

The stator is detected to be overrunning by the fact that, during overrunning, the rotational speed determined for the wheel and/or the rotor deviates by more than the first threshold value from the rotational speed difference determined between the rotor and the stator. In this case, for example, the rotational speed difference determined between the rotor and the stator is less than the rotational speed determined for the wheel and/or the rotor by more than the first threshold value, and therefore the power generator generates power having a frequency that is lower than the rotational speed of the wheel and/or of the rotor (relative to the wheel axle). In practice, this is the most common case when the stator overruns, which occurs when the stator operating in the generator mode and deflected into the operating position is deflected even further by an additional acceleration, for example due to a shock, and the torque generated by gravity on the stator is then no longer sufficient to compensate for the electrical counter-torque of the power generator on the stator and to keep itself in equilibrium. In this case, the stator then overruns in the opposite direction to the rotation of the wheel and/or of the rotor, i.e. the rotational speed of the wheel and/or of the rotor is greater than the difference in rotational speed between the rotor and the stator. If the rotor is then supplied with power in such a way that the stator is thereby accelerated, the overrunning stator will be accelerated in the opposite direction to its direction of rotation in order to bring it into a static operating position.

However, it is also possible that the stator operating in the generator mode and deflected into the operating position overruns in the direction opposite to the direction in which it was deflected from the rest position to the operating position due to the additional acceleration, for example due to a shock. In this case, the stator then overruns in the same direction of rotation in which the wheel and/or the rotor is rotating, i.e. the rotational speed of the wheel and/or of the rotor is slower than the difference in rotational speed between the rotor and the stator. If the rotor is then supplied with power in such a way that the stator is thereby accelerated, the overrunning stator will be accelerated in the opposite direction to its direction of rotation in order to bring it into a static operating position.

In the practical application of the invention, both cases can be taken into account, for example, by comparing the rotational speed determined for the wheel and/or the rotor or the rotor with the rotational speed difference determined between the rotor and the stator, the absolute value of this comparison value is taken. However, it is also possible to take the sign of the comparison value into account in order to set the first threshold value with a corresponding sign in the case of a positive or negative comparison value.

In an example, the first threshold value, it being indicative that the stator is overrunning if the first threshold value is exceeded in the first step of the method according to the invention and the second step of catching the stator by energizing the rotor is initiated, is zero, i.e. even when the smallest deviation between the rotational speed determined for the wheel and/or the rotor and the rotational speed difference determined between the rotor and the stator is established, this is an indication that the stator is overrunning. In practical application, however, a certain tolerance must be allowed. This relates, for example, to tolerances in the measurement accuracy of the methods or sensors used to determine the rotational speeds or to the fact that the stator performs slight movements around its static equilibrium position or from this position to another equilibrium position in the operating position, which movements are caused, for example, by vibrations or a load change and do not usually lead to overrunning.

The same applies to the second threshold value in the second step, below which it is detected that the stator has stopped overrunning, after which the rotor is no longer supplied with power to accelerate the stator and the power generator moves back from the motor mode to the generator mode. The second threshold value in the second step may be, but does not have to be, the same as the first threshold value in the first step.

It can therefore be provided that at least one of the threshold values can have a fixed value that is not zero, in particular lies between 0.1/s and 20/s, preferably between 0.2/s and 10/s and particularly preferably between 0.5/s and 5/s.

At least one of the threshold values may have a value that is not zero, which is dependent on the velocity of the object moved by the wheel or on the rotational speed of the rotor and/or of the wheel and is derived therefrom, in particular corresponds to a percentage of the rotational speed of the wheel and/or of the rotor.

The power generator according to the invention can be mounted on a wheel in such a way that when the wheel rotates, the rotor rotates relative to the stator. The rotor is therefore rigidly connected to the wheel, for example to the hub of the wheel, and therefore in this case the rotational speed of the rotor is equal to the rotational speed of the wheel or the rotational speed of the wheel rim. The rotational speed of the rotor can therefore not only be measured directly on the rotor itself, but can also be determined via the rotational speed of the wheel or rim. In an example, it can be provided that the rotational speed of the wheel or the rotor is determined in at least one of the following ways: using a speed sensor that measures the rotational speed, using an acceleration sensor that measures the magnitude of the centrifugal acceleration or the frequency of the change in direction in relation to gravity, using a magnetic field sensor that measures the frequency of the change in direction in relation to the earth's magnetic field or to a reference magnet, using an inductive sensor, using an ultrasonic sensor, using an optical sensor, and/or using an eccentrically aligned microphone to record tire noise of the wheel.

The difference in rotational speed between the rotor and the stator can be determined in at least one of the following ways: determining the time interval between the zero crossings of the power generated by the rotor or at least one phase of the current, and using a speed sensor, for example a Hall-effect sensor, which measures the differential rotational speed.

The power generated by the conductor windings of the rotor in the generator mode has a sinusoidal shape whose frequency is determined by the difference in rotational speed between the rotor and the stator. In an example, the rotor has, for example, three pairs of coils, each of which generates one phase. To determine the difference in rotational speed between the rotor and the stator, the zero crossings of the sinusoidal voltage of a phase of the power generator can be determined and their time interval recorded. The frequency of the phase and thus the difference in rotational speed between the rotor and the stator can be determined from the time interval between the zero crossings or the frequency of the zero crossings.

The invention is in principle suitable for use with any type of wheel used to move an object. It does not matter whether it is a wheel that is driven by a motor to move the object or whether it rotates passively when the object is moved, i.e. is set in rotation by the movement of the object. There are generally no restrictions regarding the moving object either. The object can be, for example, a wheel of an object moving on top of or on a rail, e.g. a rail vehicle (e.g. locomotive, car, rollercoaster) or a railbound transport device (e.g. an electric monorail system), or in particular a road vehicle (e.g. car, motorcycle, bicycle), or another wheel, e.g. of a trolley. A preferred field of application is the use in a wheel of a motor vehicle, in particular a light-metal wheel. Preferably, the object moved by the wheel is a vehicle.

A second aspect of the invention, which can be used in combination with or independently of the first aspect according to the invention explained above of catching a continuous stator, is aimed at reducing the frequency with which the stator overruns via suitable measures. For this purpose, in an electromagnetic power generator which has a rotatably mounted stator having an eccentric center of mass and a rotor which can rotate relative to the stator, and which power generator can be mounted on a wheel of an object movable via the wheel in such a way that when the wheel rotates, the rotor rotates relative to the stator and the power generator thereby generates power, it is proposed in particular according to the second aspect of the invention that the power output by the power generator in a generator mode be controlled using closed-loop control via load control such that it remains below a prespecified limit value.

During regular operation of the power generator, i.e. in the power-generating generator mode, while the rotor is rotating together with the wheel, the stator does not rotate or overrun, as already mentioned, but is merely deflected from its rest position into an almost static operating position in which the torque on the stator provided by the eccentric center of mass of the stator corresponds to the torque on the stator provided by the generation of power by the power generator. The second aspect of the invention is based on the finding that the power generator is less sensitive to influences that trigger overrunning if, in the generator mode of the power generator, the deflection of the stator from its vertical rest position to the operating position is less than 90°, preferably less than 60°, in particular between 30° and 60°.

The second aspect of the invention is therefore focused on the control or closed-loop control of the power generator in the normal generator mode in such a way that the stator is deflected by no more than approximately 90° relative to the vertical. Without load control, as the velocity of the object moved by the wheel increases, i.e. as the traveling speed increases, the deflection of the stator would increase and at some point the stator would overrun. However, load control reduces the power consumption to such an extent that the deflection of the stator is limited even at high rotational speeds of the wheel, without increasing as the rotational speed of the wheel increases.

In an example, the load control comprises in particular the following steps: a first step to determine a speed characteristic of a current velocity of the object moved by the wheel, from which it is possible to deduce the magnitude of the current maximum electrical power that can be generated by the power generator without load control; and a second step in which a check is made to see whether the determined characteristic rotational speed is greater than a switch-on threshold, in particular defined by the user, if the response to the second step is affirmative, a third step in which an electrical load, in particular a user-defined electrical load, is drawn from the power generator, and a fourth step in which the characteristic speed is again determined, as well as a fifth step in which a check is made to see whether this characteristic rotational speed is lower than a switch-off threshold, in particular defined by the user, if the response to the fifth step is negative, a sixth step in which the generator load, i.e. the power delivered by the power generator, is controlled using closed-loop control on the basis of the characteristic speed, if the response to the fifth step is affirmative, an alternative sixth step in which the generator load is switched off.

This flowchart is preferably carried out in a continuous closed control loop, wherein the closed-loop control preferably only starts when the electrical load delivered by the power generator exceeds the switch-on threshold and does not fall below the switch-off threshold. The use of the switch-on threshold prevents the load control from already interfering at low electrical loads, and the use of the switch-off threshold prevents the load control from alternatingly switching on and off at a high frequency. The switch-off threshold can be lower than the switch-on threshold.

The load drawn from the power generator in the third step can be adjusted so that it is only a low electrical load. A low electrical load in this context can preferably be an electrical load which is considerably lower than the maximum electrical power that can be generated by the power generator, for example 0.5% to 20%, preferably 1% to 10% and particularly preferably 2% to 5% of the maximum power, or which is considerably lower than the electrical power that can be generated in the current operating state of the power generator, for example 0.5% to 20%, preferably 1% to 10% and particularly preferably 2% to 5% of this power.

The rotational speed of the wheel and/or of the rotor or difference in rotational speed between the rotor and the stator can be determined as the characteristic rotational speed. Since in the generator mode, the rotational speed of the wheel approximately corresponds to the difference in rotational speed between the rotor and the stator when the stator is not overrunning, the power output by the power generator can be controlled using closed-loop control on the basis of the rotational speed of the wheel and/or of the rotor or the difference in rotational speed between the rotor and the stator. From both values it is possible to deduce the magnitude of the current maximum electrical power that can be generated by the power generator without load control.

The rotational speed of the wheel and/or of the rotor and/or the difference in rotational speed between the rotor and the stator can be determined in the same way during load control, i.e. using the same methods and/or sensors as when catching the stator. During load control, the rotational speed of the wheel and/or of the rotor and/or the difference in rotational speed between the rotor and the stator can be performed in exactly the same way as when catching the stator, and therefore no additional structural effort is required therefor during load control.

It can be provided that in the sixth step, in which the generator load, i.e. the power delivered by the power generator, is controlled via load control, the load control is carried out according to a prespecified characteristic of the power generator and a predefined or programmed characteristic map is used in which the electrical power of the power generator in the generator mode is established on the basis of the characteristic variable or the velocity of the object moved by the wheel.

The power generator according to the invention carries out the method according to the invention. The power generator has electrical components and a housing with which it can be mounted on a wheel, wherein the housing can preferably be inserted into a cylindrical cavity of the wheel hub and/or the housing is adapted to the wheel. The stator can be preferably arranged concentrically with the rotor.

A wheel is also provided, in particular for a vehicle, in particular a light-metal wheel, can comprise a hub which has a cylindrical cavity, wherein an electromagnetic power generator according to the invention is arranged in the cylindrical cavity of the hub.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exploded view of an example of a power generator according to the invention,

FIG. 2 shows a perspective view of FIG. 1,

FIG. 3 shows an isometric view of a full section of FIG. 2,

FIG. 4 shows a side view of the full section of FIG. 2,

FIG. 5 shows a perspective view of a wheel comprising the power generator according to FIG. 1,

FIG. 6 shows a radial full section of FIG. 5,

FIG. 7 shows a schematic view of the deflection of the stator in the generator mode of the power generator according to FIG. 1,

FIG. 8 shows an example flowchart of a process for open-loop control of the power generator when re-catching an overrunning stator,

FIG. 9 shows a diagram in the generator mode of the power generator,

FIG. 10 shows an exemplary flowchart of the process for closed-loop control of the power generator with load control in the generator mode,

FIG. 11 shows a characteristic curve for implementing load control of the power generator, and

FIG. 12 shows a block diagram of the power generator.

### DETAILED DESCRIPTION

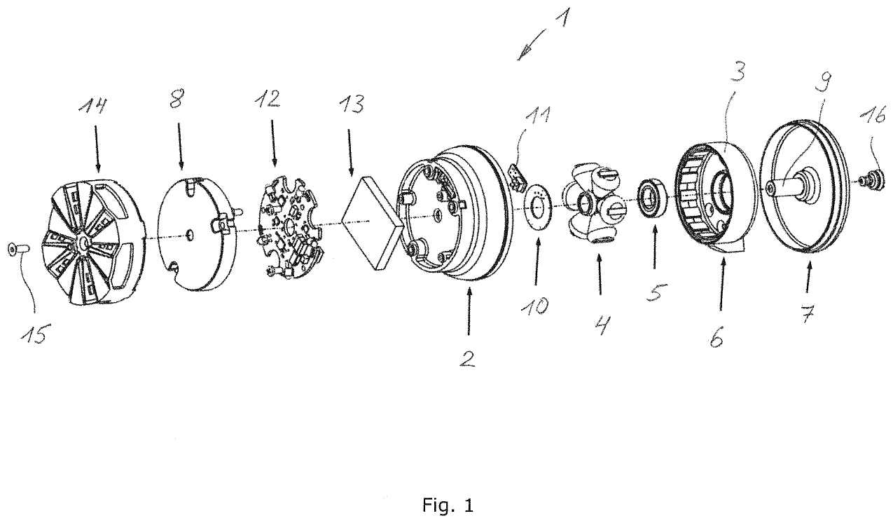

FIG. 1 is an exploded view of an example of a power generator 1 according to the invention, comprising a housing 2 and all associated components to form a complete module which can be inserted, for example, into the cylindrical cavity of a hub 19 of a wheel 17. As noted above, DE 20 2018 000 629 U1, which is incorporated herein by reference, comprises a power generator. The power generator 1 according to FIG. 1 further refines the known power generator and amongst other additional components, has further components and electronics to catch the rotatably mounted stator 3 in the event that it overruns and for controlling the power output by the power generator 1 using closed-loop control via load control.

The core component of the power generator 1 is formed by a rotatably mounted stator 3 having an eccentric center of mass and a rotor 4 which is rotatable relative to the stator 3 and is arranged concentrically with the stator 3. The stator 3 is made of ferromagnetic material or is equipped with permanent magnets around its circumference. The stator 3 is arranged to be freely rotatable relative to the rotor 4 via a ball bearing 5 and has a radially extending weight part 6 over part of the circumference, which results in an eccentric center of mass of the stator 3 such that the stator 3 does not normally rotate with the rotating wheel 17 in which the power generator 1 is mounted, but remains oriented substantially vertically downward due to gravity. The rotor 4 is equipped with conductor windings, for example with three pairs of coils in FIG. 1. When the conductor windings of the rotor 4 are rotated with the rotor 4 in the stator 3, a voltage is induced therein and the power generator 1 generates power.

The stator 3 and the rotor 4 are arranged in a housing 2 of the power generator 1, which comprises a retaining ring which is closed on an axially lower side, the rear side in FIG. 1, by a rear housing cover 7 and on an axially upper side, the front side in FIG. 1, by a front housing cover 8. The rear housing cover 7 carries a central axial bearing shaft 9, which rotates in the same way when the housing 2 or the rear housing cover 7 rotates. The ball bearing 5 for the stator 3 and the rotor 4 are arranged on the bearing shaft 9. The stator 3 can rotate on the bearing shaft 9 via the ball bearing 5 and thus remain in a fixed position in space when the housing 2 is rotating. The rotor 4, on the other hand, is not rotatably arranged on the bearing shaft 9 such that when it rotates it rotates together with the housing 2.

A coil board 10 having a contact piece 11 is used to electrically contact the coils of the rotor 4, which contact piece establishes the electrical connection to an electronics board 12 arranged on a plate 13 that serves as a base support or can contain an electrical energy storage device which can be recharged via the power generator 1, for example a rechargeable battery (a lithium-ion battery or another type of battery) or a capacitor, with which the electrical energy generated by the power generator 1 for supplying power to a consumer is temporarily stored. A trim disk 14 is attached to the front cover 8 of the housing and all parts are held together by an axial screw 15 and its associated counterpart 16.

When the housing 2 is connected to the wheel 17 for conjoint rotation, for example inserted into the cavity of the hub 19 of the wheel 17, the power generator 1 arranged in the housing 2 will be able to generate and provide electrical power when the wheel 17 is rotating, without any structural changes to the wheel 17 being necessary. When the wheel 17 is rotating, the rotor 4 rotates together with the wheel 17 such that when the wheel 17 is rotating, the rotor 4 rotates relative to the stator 3 and the power generator 1 thereby generates power. In this case, the stator 3 is statically deflected from its rest position into an operating position and from the rotation of the wheel 17 the power generator 1 generates electrical energy that is directly available in the wheel 17.

The stator 3 is freely rotatable due to being mounted on the ball bearing 5, which is necessary so that it does not rotate together with the rotating wheel 17 but remains in a stationary operating position. However, external influences, such as vibrations, can cause the stator 3 to overrun, i.e. to start undesirably rotating. The invention is directed to catching the rotatably mounted stator 3 in the event of it overrunning and to controlling the power output by the power generator 1 by closed-loop control via a load control in order to make the power generator 1 less sensitive to influences that trigger overrunning. The invention is substantially realized by functions provided by the electronics board 12. These relate in particular to catching the rotatably mounted stator 3 in the event of it overrunning or controlling the power output by the power generator 1 using closed-loop control via load control.

The electronics board 12 or other elements of the power generator 1 can in particular comprise one or more components: to detect whether the stator 3 is overrunning, to determine the rotational speed of the wheel and/or the rotor, to determine the rotational speed difference between the rotor 4 and the stator 3, to compare the rotational speed determined for the wheel and/or the rotor and the rotational speed difference determined between the rotor 4 and the stator 3, to detect whether the stator 3 is overrunning due to the fact that the rotational speed determined for the wheel and/or the rotor deviates by more than a first threshold value, in particular a user-defined first threshold value, from the rotational speed difference determined between the rotor 4 and the stator 3, whereby, in the event that the it is detected that the stator 3 is overrunning, to stop the stator 3 from overrunning by supplying power to the rotor 4 in such a way that the stator 3 is thereby accelerated, for example for a prespecified length of time or until the rotational speed of the wheel and/or of the rotor deviates from the rotational speed difference between the rotor 4 and the stator 3 by less than a second threshold value, in particular defined by the user, to switch the power generator from the generator mode, in which power is generated in the conductor windings of the rotor 4, to a motor mode, in which a rotating electromagnetic field is generated by the conductor windings of the rotor 4 supplied with power, as a result of which switch the overrunning, rotating stator 3 is driven and brought back into a stationary operating position via the power supply to the rotor 4, wherein the rotor 4 is preferably supplied with power in the motor mode in such a way that it generates a magnetic rotating field which rotates at the rotational speed determined for the wheel or the rotor or the rotational speed difference determined between the rotor 4 and the stator 1, to determine a characteristic rotational speed of a current velocity of the object moved by the wheel, from which it is possible to deduce the magnitude of the current maximum electrical power that can be generated by the power generator 1 without load control, to check whether the determined characteristic rotational speed is greater than a switch-on threshold, in particular defined by the user, to draw an electrical load from the power generator 1, to check whether the determined characteristic rotational speed is lower than a switch-off threshold, in particular defined by the user, to control the power delivered by the power generator 1 using closed-loop control on the basis of the characteristic rotational speed, to switch off the generator load, to stabilize or control the electrical voltage generated by the power generator 1 using closed-loop control, to store the electrical energy generated by the power generator, to control the power generator 1 in the generator mode, and to control the power generator 1 in the motor mode.

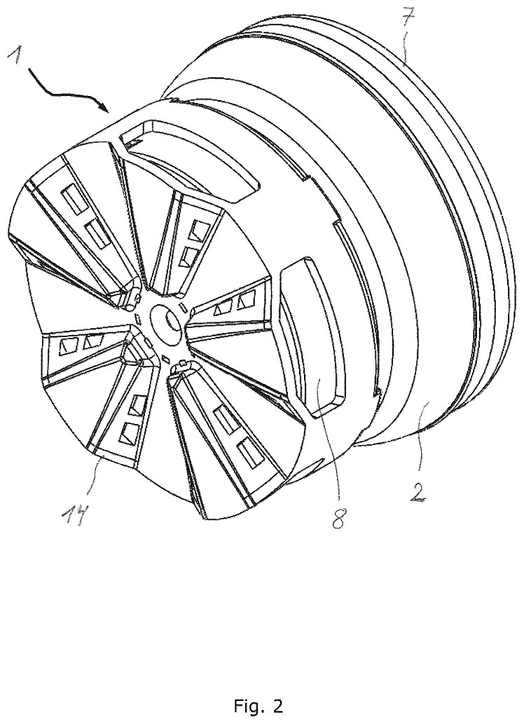

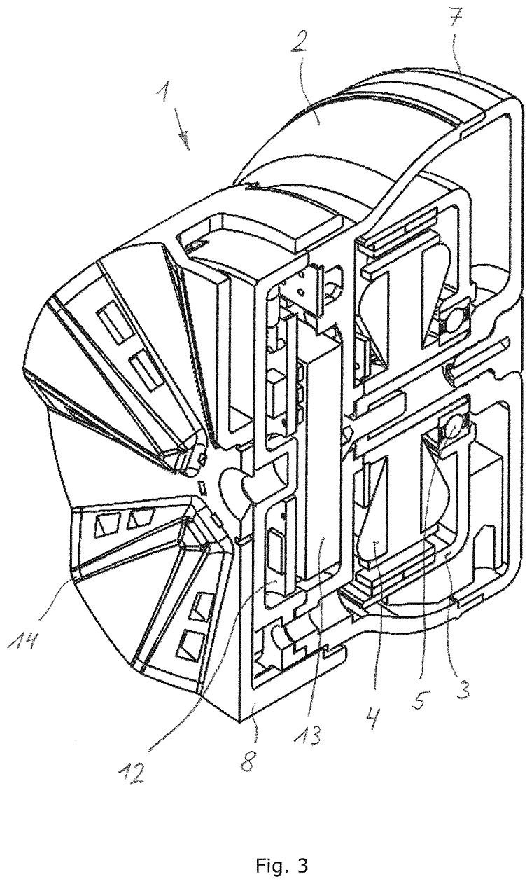

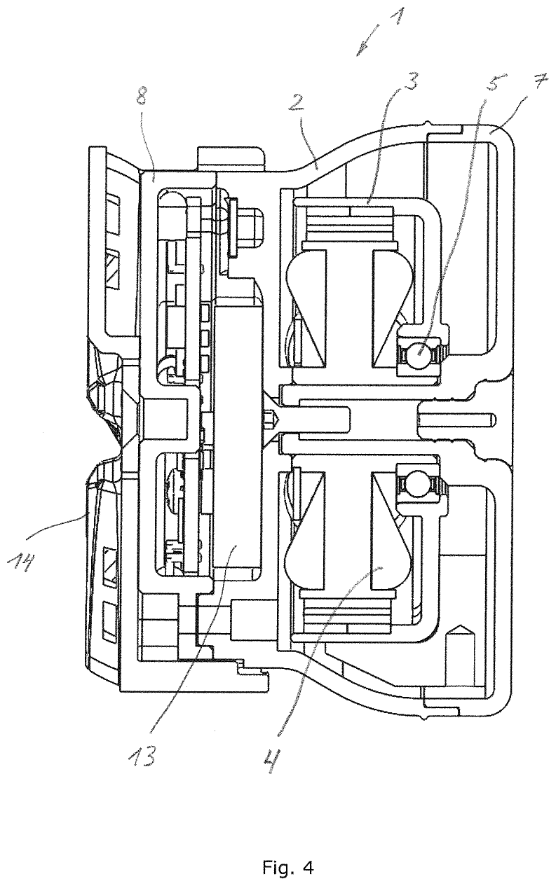

FIG. 2 is a perspective view of the power generator 1 from FIG. 1, FIG. 3 is an isometric view of a full section of FIG. 2, and FIG. 4 is a side view of a full section of FIG. 2.

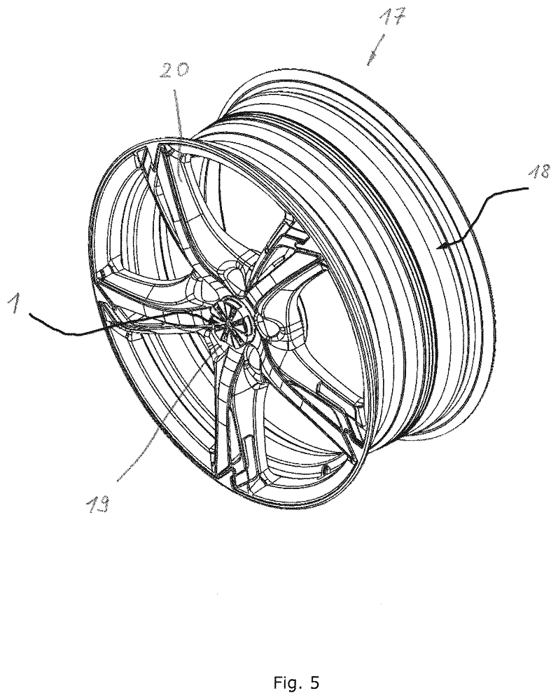

FIG. 5 is a perspective view of the wheel 17 comprising a power generator 1 according to the invention. The wheel 17 shown by way of example is a conventional light-metal wheel of a motor vehicle having a rim 18 onto which a tire can be mounted. The wheel 17 comprises a radially centered hub 19, the rim 18 that is coaxial therewith and a radial part extending between the rim 18 and the hub 19. The radial part can, for example, be a wheel disk, also comprising interruptions, or can consist of a plurality of wheel spokes 20 distributed over the circumference of the wheel, which extend radially from the hub 19 to the rim 18, for example five or seven wheel spokes 20 which are preferably uniformly distributed in the circumferential direction.

The hub 19 is hollow-cylindrical. When the wheel 17 is mounted on the axle of a vehicle, the vehicle shaft projects into the cavity of the hub 19, the wheel 17 being connected to a fastening disk rigidly connected to the axle of the vehicle via connecting screws inserted through openings surrounding the hub 19 such that when the axle of the vehicle rotates, the wheel 17 is also made to rotate, or, in the case of a non-driven wheel 17, the wheel 17 can rotate on the axle when the vehicle is moving.

According to FIG. 5, the power generator 1 has a housing 2 with which it is mounted on the wheel 17, wherein the housing 2 is inserted into a cylindrical cavity of the hub 19 of the wheel 17 and is adapted to the wheel 17. The adaptation of the housing 2 to the wheel 17 may relate to the design and/or structure or dimensions of the wheel 17, of the hub 19 or of the cavity. The power generator 1 forms an autonomous unit, i.e. one that is independent of an external energy supply, or a module that is suitable for use on several different rims 18 or wheels 17.

The power generator 1 can also be designed for use with any direction of rotation of the wheel 17, for example for the wheels 17 of a vehicle on both the left-hand and right-hand sides of the vehicle. It can be provided that the direction of rotation of the wheel 17, in particular when the object moved thereby is traveling forward, is automatically detected and evaluated via the electronics board 12 or a sensor. For example, it can be provided that the power generator 1 is designed for use in two different directions of rotation and thus for use on the left-hand and right-hand sides of the vehicle. A four-quadrant operation can be realized, which takes into account the following parameters: generator mode, motor mode, counterclockwise rotation and clockwise rotation, and in which the direction of rotation is thus automatically detected.

In the case of the wheel 17 shown by way of example in FIG. 5, the electromagnetic power generator 1 is arranged in the cylindrical cavity of the hub 19. As already mentioned, the power generator comprises the trim disk 14, which serves as a hub cap, takes up a small part of the outer height of the cavity and with which it is inserted in the axially outer region of the cavity in the center of the hub 19 for conjoint rotation. When the wheel 17 rotates, the trim disk 14, the housing 2 comprising the front housing cover 8 and rear housing cover 7, the electronics board 12, the plate 13, the coil board 10 and the rotor 4 comprising the conductor windings or pairs of coils rotate at the same rotational speed as the wheel 17, while the stator 3, which can rotate freely relative to the rotor 4, remains in a fixed static position relative to the orientation of the gravitational force due to its eccentric center of gravity caused by the weight part 6.

As a result of the rotor 4 rotating in the stator 3 when the wheel 17 rotates, electrical power is generated in the rotor 4, which can be supplied to an electrical consumer or a rechargeable electrical energy storage device in the wheel 17 under the control of the electronics board 12. In this way, electrical energy can be made available on or in the wheel 17 rotating on a vehicle without the need to modify the wheel 17 and without a large amount of effort, which energy is obtained solely from the rotation of the wheel 17. The power generator 1 thus represents an energy harvester, i.e. a component that utilizes energy available in the operating environment of the component.

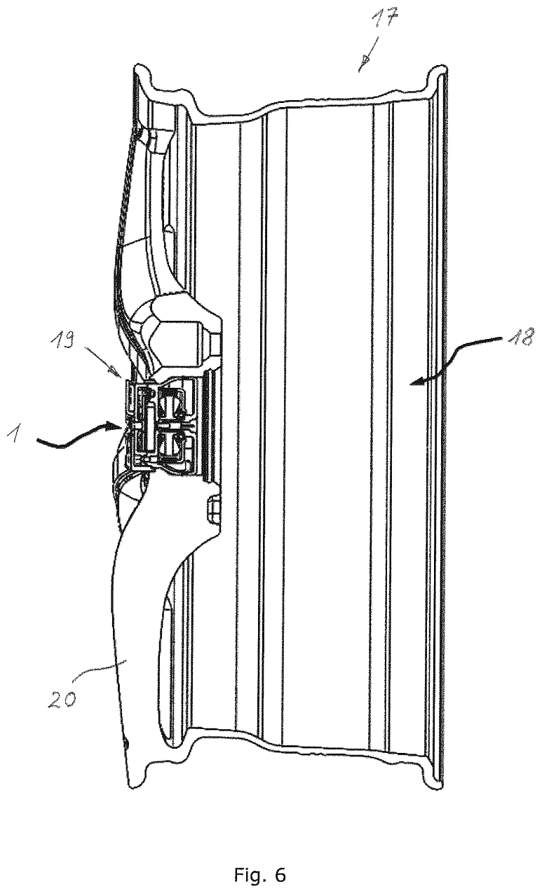

FIG. 6 shows a full radial section of the wheel 17 comprising the power generator 1 shown in FIG. 5.

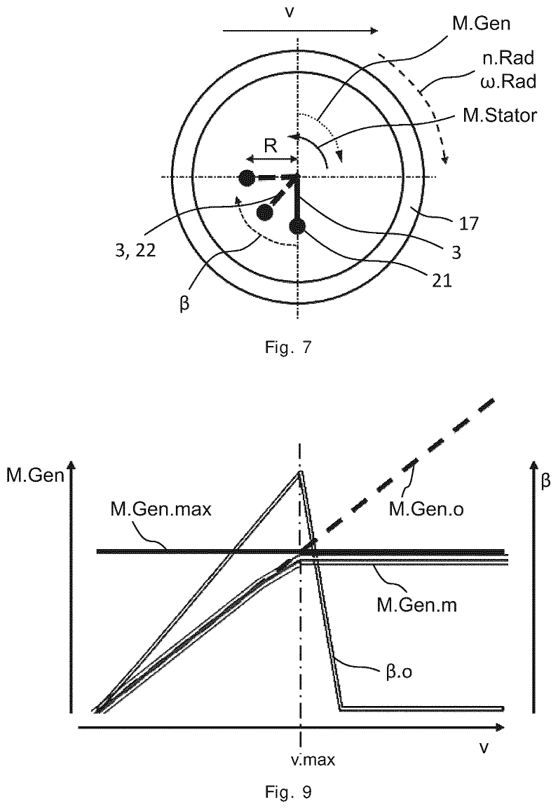

FIG. 7 is a schematic view of the deflection of the stator 3 in the generator mode of the power generator 1, i.e. when generating power in a rotating wheel 17. If the object moved by the wheel 17 moves at the velocity v, the wheel 17 will rotate at the associated rotational speed n.Rad or the angular velocity ω.Rad. The rotor 4 of the power generator 1 comprising the pairs of coils also rotates at the same rotational speed n.Rotor=n.Rad. The stator 3 has an eccentric center of mass 21 and is freely rotatably mounted. When the stator 3 is rotated, the deflection angle β of its center of mass 21 changes. For illustration purposes, the stator 3 is shown in FIG. 7 as a swinging pendulum 22.

In the rest position, i.e. when the wheel 17 and the rotor 4 are stationary and the power generator 1 is not generating any electrical power, the rotatably mounted stator 3, designed as a pendulum 22, is rotated downward into a vertical rest position by gravity due to its eccentric center of mass 21 and is held in this rest position. The deflection angle β is then 0°. In the generator mode, i.e. when the wheel 17 and the rotor 4 are rotating, the power generator 1 generates electrical current or electrical power. The rotor 4 causes a corresponding torque M.Gen of the power generator 1 on the stator 3, by which the stator 3 is rotated by the deflection angle β from the rest position into an operating position until the torque M.Stator of the stator 3 caused by the weight corresponds to the torque M.Gen of the power generator 1 caused by induction, the gravity acting on the stator 3 or pendulum 22 therefore provides the counter-torque to the torque M.Gen of the power generator 1. In the operating position therefore:

M.Stator=M.Gen
where
M.Stator=counter-torque of the stator
M.Gen=torque of the generator

From this equation it follows that, in equilibrium, the deflection angle β of the stator 3 is of such a size that the following relationship applies:

$$r \times m . Stator \times g \times sin β = ( U \times I ) / ω . Rad$$

where
r=distance of the eccentric center of mass of the stator from its axis of rotation
m.Stator=mass of the stator (the pendulum)
g=gravitational acceleration
β=deflection angle of the stator from the rest position
U=voltage of the power generator
I=current of the power generator
ω.Rad=angular velocity of the wheel or rotor

During normal operation, the deflection of the stator 3 from the rest position is almost static or constant and is determined from the torque M.Gen of the power generator 1 caused by induction. However, disturbances occurring during driving operation can cause the stator 3 to be deflected from the operating position to such an extent that it overruns, i.e. begins to unintendedly and uncontrollably rotate. By catching the stator 3 according to the invention, the occurrence of this overrun in the event of a fault is detected and the overrun is stopped.

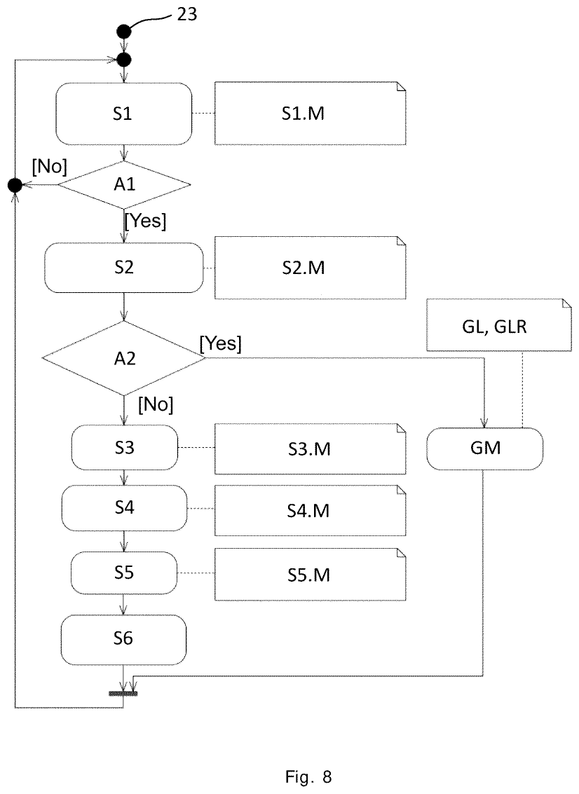

FIG. 8 shows an exemplary flowchart of a method according to the invention for operating the power generator 1 when re-catching the overrunning stator 3. After initialization 23 of the open-loop controller, the rotational speed n.Rad of the wheel 17 and/or of the rotor 4 relative to the fixed wheel axle is determined in a first step S1. This is done using a component S1.M for determining the system status in the generator mode, for example by reading out and evaluating data from a speed or acceleration sensor installed for this purpose or an alternative component.

In the next step, a query A1 checks whether the wheel 17 is rotating, i.e. whether the rotational speed n.Rad of the wheel 17 or the corresponding rotational speed n.Rotor of the rotor 4 is greater than zero. If the response is affirmative, the rotational speed difference n.Diff between the rotor 4 and the stator 3 is determined in the following step S2. This is done using a component S2.M for determining the system status in the generator mode, for example by determining the time interval between the zero crossings of the sinusoidal voltage of a power phase of the rotor 4, from which the rotational speed difference n.Diff can be determined. Alternatively, signals from a Hall-effect sensor installed in the wheel 17 may also be used.

In the next step, the rotational speed n.Rad determined for the wheel 17 and/or the rotational speed n.Rotor determined for the rotor 4 is compared with the rotational speed difference n.Diff determined between the rotor 4 and the stator 3 in a query A2 and a check is made to see whether the two values match or differ from each other by more than a first threshold value. In particular, the first threshold value can be defined by the user. If the two values within the tolerance specified by the first threshold value are equal, a fault is not present and stator 3 has not overrun. The power generator 1 then continues to remain in the generator mode GM. In this mode, a generator load GL can be supplied with power by the power generator 1 and a load control GLR of the power generator 1 can optionally be carried out, as explained below. The method for detecting and stopping the overrun of the stator 3 is constantly repeated in a loop, which is illustrated in the flow chart by a return to the first step S1.

If, however, query A2 determines that the two values differ from one another by more than the tolerance specified by the first threshold value, i.e. for example if the rotational speed difference n.Diff between the rotor 4 and the stator 3 is lower than the rotational speed of the wheel 17 and/or of the rotor 4, it is concluded that a fault has occurred and the stator 3 is overrunning, and the steps for stopping the stator 3 overrunning and for re-catching the stator 3 are initiated. To stop the stator 3 from overrunning, the power generator 1 is then switched from the generator mode GM to the motor mode in the switching step S3, for which purpose switching off the generator load GL initially serves as component S3.M. In the following acceleration step S4, the rotor 4 is energized in such a way that the stator 3 is thereby accelerated. This is preferably done by power being supplied to the rotor 4 in such a way that it generates a rotating magnetic field which rotates at the rotational speed n.Rad determined for the wheel 17 and/or the rotor 4 or the rotational speed difference n.Diff determined between the rotor 4 and the stator 3. The rotor 4 is energized until the position of the stator 3 is stationary again, i.e. it is no longer rotating relative to the wheel axle but is stationary relative to the wheel axle, and thus the relative rotational speed n.Diff between the stator 3 and rotor 4 is once again consistent with the rotational speed n.Rad of the wheel 17 and/or the rotor 4. The component S4.M in the acceleration step S4 thus serves to increase the rotational speed of the stator 3 via the predefined characteristics of the power generator 1.

Following on from the acceleration step S4, a waiting step S5 is carried out in which the power generator 1 is not energized during a waiting time of, for example, 5 s so that the stator 3 can settle. The associated component S5.M serves to switch off the power supply to the power generator 1 in the motor mode. Alternatively or in addition to the waiting step S5, a query can also be made as to whether the rotational speed of the wheel 17 and/or of the rotor 4 deviates by less than a second threshold value from the rotational speed difference n.Diff determined between the rotor 4 and the stator 3. The second threshold value may also be definable by the user and the first and second threshold values may be the same or different. After the stator 3 has been successfully re-caught, the motor mode automatically switches to the generator mode GM in the switching step S6 and regular, fault-free operation of the power generator 1 is continued. In this case, too, the individual steps are repeated, i.e. the flow chart is continued in loops.

The diagram shown in FIG. 9 in addition to FIG. 7 qualitatively represents the torque M.Gen of the power generator 1 arising between the rotor 4 and the stator 3 in the generator mode GM and the corresponding position of the stator 3, i.e. the deflection angle β of the stator 3 from the rest position, in each case on the basis of the velocity v of the vehicle. The solid horizontal line in the diagram shows the maximum permissible torque M.Gen.max of the power generator 1. The dashed line shows the torque M.Gen.o of the power generator 1 as would result without intervention, open-loop or closed-loop control. The double line shows the deflection angle β.o of the stator 3 as it would occur without intervention, open-loop control or closed-loop control. When the limit velocity v.max is reached, the deflection angle β is 90°, i.e. the pendulum 22 is in the horizontal position. In this position, the counter-torque M.Stator of the stator 3 reaches its maximum and decreases again as the deflection angle β continues to increase. An increase in the vehicle velocity v beyond the limit velocity v.max would therefore, without further closed-loop control, result in the stator 3 overrunning, whereby the stator 3 uncontrollably rotates about its axis of rotation.

As a result, above a certain velocity v of the vehicle or the corresponding rotational speed n.Rad of the wheel 17, the electrical power delivered by the power generator 1, i.e. the power of the power generator 1, should no longer increase so that the stator 3 is not deflected to such an extent that it can no longer provide the required counter-torque. The triple line shows the course of the torque M.Gen.m of the power generator 1, which is controlled using closed-loop control via a load control, for the limiting case in which the limit value of 90° is assumed for the maximum permissible deflection angle β. Preferably, load control is carried out in such a way that, when the wheel 17 is in driving operation, the maximum deflection of the stator 3 by the deflection angle β from its vertical rest position to the operating position is a maximum of 90°.

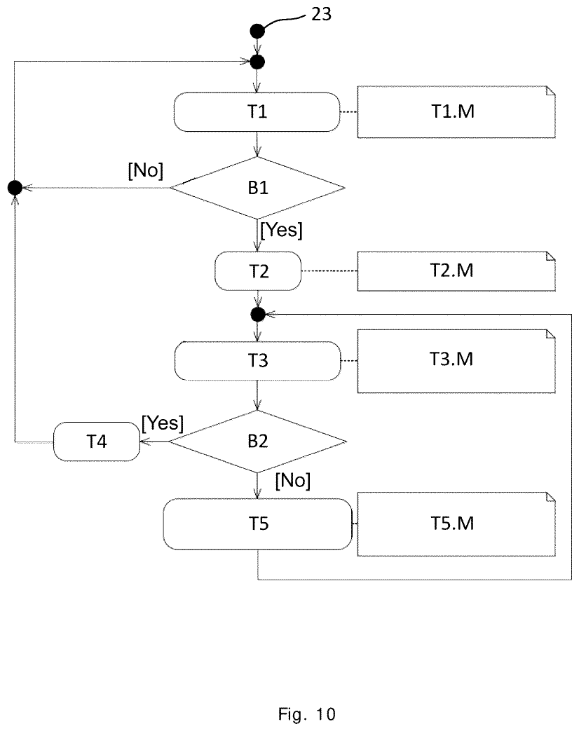

FIG. 10 shows an exemplary flowchart of the load control of the power generator 1, which serves to limit the frequency with which the stator 3 overruns.

After initialization 23 of the open-loop controller, in a first step TI a speed characteristic of the current velocity v of the object moved by the wheel 17 is determined, from which it is possible to deduce the magnitude of the current maximum electrical power that can be generated by the power generator 1 without load control. This characteristic speed determined can in particular be the rotational speed n.Rad of the wheel and/or of the rotor 4 relative to the fixed wheel axle or the rotational speed difference n.Diff between the rotor 4 and the stator 3. The determination is made using a component T1.M for determining the system status, for example by determining the time interval between the zero crossings of the sinusoidal voltage of a phase of the rotor 4, from which the differential rotational speed n.Diff can be determined. Alternatively, the use of signals from a Hall-effect sensor installed in the wheel 17 is also suitable.

In the next step, a query B1 checks whether the characteristic speed determined is greater than a user-defined switch-on threshold. If the response is affirmative, an electrical load will be drawn from the power generator 1 in the following step T2. This load is preferably slight, i.e. considerably lower than the maximum electrical power that can be generated by the power generator than the electrical power that can be generated in the current operating state of the power generator. The component T2.M for this purpose is a power generator load control, which sets a minimum power consumption. In the following step T3, the characteristic speed is determined again. The determination is made using a component T3.M for determining the load control system status, for example by determining the time interval between the zero crossings of the sinusoidal voltage of a phase of the rotor 4. In the subsequent query B2, a check is then made to see whether this characteristic speed is lower than a switch-off threshold.

If the response to query B2 is affirmative, the generator load will be switched off in step T4 and the method returns to step T1. If, however, the response to query B2 is negative, the generator load, i.e. the power delivered by the power generator 1, will be controlled using closed-loop control in a step T5 on the basis of the characteristic speed. The load control is thus carried out according to the predefined characteristics of the power generator 1 in the generator mode. The component T5.M for this is a power generator load control, which preferably uses a predefined or programmed characteristic map with the characteristics of the power generator 1. Via load control, the power of the power generator 1 and thus the torque of the power generator 1 can be controlled using closed-loop control in the generator mode. The process returns to step T3 in a closed control loop.

Via load control, an inadmissibly high generator torque between the rotor 4 and the stator 3 can thus be prevented, which, without load control, would lead to the stator 3 overrunning, as explained with reference to FIG. 9. The load control is carried out by the deflection angle of the stator 3 being limited to a limit value of less than 90° in the generator mode. Above a certain velocity v of the vehicle or above the corresponding rotational speed of the wheel 17 or of the rotor 3, the load control limits the electrical power of the power generator 1 in order to restrict the maximum deflection of the stator 3 in the generator mode.

Within the scope of the invention, it has been found that load control is preferably carried out in such a way that, when the wheel 17 is in driving operation, the maximum deflection of the stator 3 by the deflection angle β from its vertical rest position to the operating position is no more than 90°. The power generator 1 is then less sensitive to influences that trigger overrunning, without the load control excessively restricting the torque between the rotor 4 and the stator 3 and thus the electrical power generated by the power generator 1.

The above-described load control of the power generator 1 can also be used without the method for re-catching an overrunning stator 3. The load control can be used in combination with re-catching the stator 3 in the event of the stator overrunning. This is because load control fundamentally limits the electrical power generated by the power generator 1. In order to achieve the highest possible energy yield, this power limitation should be as low as possible. If load control is carried out without the method for detecting and terminating the overrun, the electrical power of the power generator 1 will have to be greatly limited in order to prevent the stator 3 from overrunning as much as possible. However, if load control is used in combination with the method for detecting and terminating the overrun, the electrical power of the power generator 1 will need to be restricted to a much lesser extent. In this case, an occasional overrun of the stator 3 can be accepted, since the overrun does not continue but the stator 3 is immediately re-caught. When load control is combined with re-catching the stator, the power generator 1 can thus operate in an optimized range in which a higher energy yield is achieved than with just load control.

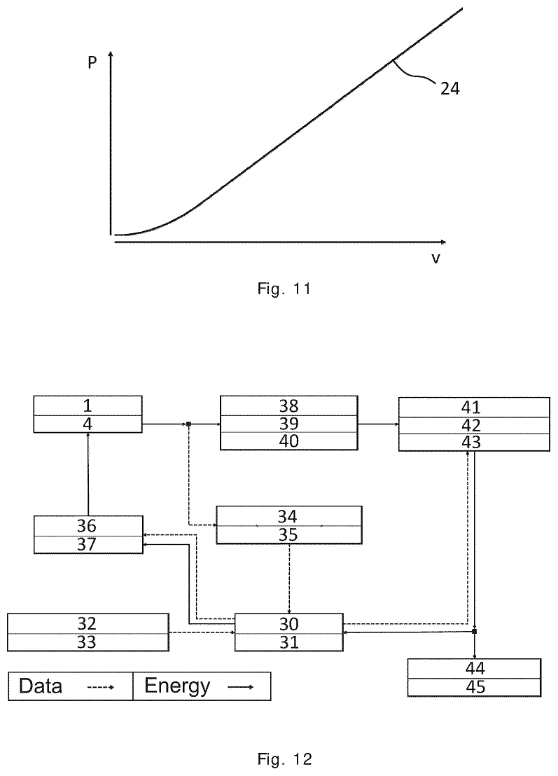

FIG. 11 shows, as an example of a characteristic map used in the load control illustrated in FIG. 10, a characteristic curve 24 used to implement the load control of the power generator 1 in the generator mode, which curve is programmed or stored. The diagram qualitatively shows the electrical output power P of the power generator 1 controlled using closed-loop control as a function of the vehicle velocity v. The charging current for an electrical energy storage device, for example a rechargeable battery, is set via a charging controller for the linear portion of the characteristic map curve so as to be proportional to the output power P of the power generator 1. The power consumed by the charge controller corresponds to the output power of the generator P. The voltage at the charge controller is kept constant over the entire speed range of the vehicle, while the output voltage of the power generator increases with increasing vehicle velocity v. The result is different values for the power of the power generator 1 and the charging current delivered by the charge controller.

FIG. 12 shows a schematic block-diagram-like representation of the electrical, electronic or electrotechnical structure of the overall system in a power generator 1. It shows the energy flow and the data flow between the individual subsystems and components. The core and node point is a controller 30 in which all system data are combined and processed and which controls the system components. It preferably comprises a microprocessor or micro-controller 31. The controller 30 receives data from the determination 32 of the rotational speed of the wheel 17 and/or of the rotor 4, for example from an acceleration sensor 33, and from the determination 34 of the rotational speed difference between the rotor 4 and the stator 3, for example via the evaluation 35 of zero crossings of a power phase of the generator voltage. With this data, the overrunning stator 3 can be re-caught or load control can be carried out. The rotor 4 of the power generator 1 can be controlled via the motor controller 36 of the power generator 1, for example an EC motor driver 37. The output-side voltage stabilization 38 of the power generator 1 serves to rectify and stabilize the preferably three-phase output voltage of the power generator 1. For example, it comprises a B6 rectifier 39 and a step-up/step-down converter 40.

Via the controller 30, the motorized control of the rotor 4 or the power generator 1 is carried out via the power generator controller 36 (e.g. an EC motor driver 37) and the charging current of an energy storage device 41 is influenced. The energy storage device 41 comprises, for example, a battery management system 42 and an electrical energy storage device 43, e.g. a lithium-ion battery. An electrical load 44 supplied with power by the power generator 1, for example LED lighting 45, is connected to the energy storage device 41.

All or a selection of the components shown can be arranged on a common electronics board.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an electromagnetic power generator that comprises a rotatably mounted stator having an eccentric center of mass and a rotor that is adapted to rotate relative to the stator, the power generator being adapted to mounted on a wheel of an object that is movable via the wheel such that when the wheel rotates, the rotor rotates relative to the stator and the power generator thereby generating power in a generator mode, the method comprising:
determining a rotational speed of the wheel and/or of the rotor;
determining a rotational speed difference between the rotor and the stator;
comparing the rotational speed determined for the wheel and/or the rotor and the rotational speed difference determined between the rotor and the stator;
detecting whether the stator is overrunning by determining whether the rotational speed determined for the wheel and/or the rotor deviates by more than a first threshold value or a threshold value defined by a user, from the rotational speed difference determined between the rotor and the stator; and
stopping, in an event in which it is detected that the stator is overrunning, the stator from overrunning by supplying power to the rotor such that the stator is thereby accelerated.

2. The method according to claim 1, wherein power is supplied in that the power generator is switched from the generator mode, in which power is generated in the rotor or in conductor windings of the rotor, to a motor mode, in which a rotating electromagnetic field is generated by the rotor or conductor windings of the rotor supplied with current, via which rotating electromagnetic field the overrunning stator is driven and is brought back into an operating position or a stationary operating position, via the power supply to the rotor.

3. The method according to claim 2, wherein the rotor is supplied with power when in the motor mode such that it generates a magnetic rotating field which rotates at the rotational speed determined for the wheel and/or the rotor or the rotational speed difference determined between the rotor and the stator.

4. The method according to claim 1, wherein the rotor in the motor mode, is supplied with power until the rotational speed of the wheel and/or the rotor deviates by less than a second threshold value or a second threshold value defined by the user, from the rotational speed difference between the rotor and the stator.

5. The method according to claim 1, wherein the rotor in the motor mode, is supplied with power for a predetermined length of time and the power generator is then switched back to the generator mode.

6. The method according to claim 5, wherein the predetermined length of time of the motor mode is selected on the basis of the rotational speed determined for the wheel and/or the rotor and/or a velocity of the object moved by the wheel, and a predefined or programmed characteristic map is used in which the prespecified length of time of the motor mode is defined on the basis of the rotational speed of the wheel and/or of the rotor and/or the velocity of the object moved by the wheel.

7. The method according to claim 1, wherein after the power generator is switched to the motor mode, a pause time or a user-defined pause time passes and only after the pause time has elapsed is the power generator switched to the generator mode and power is drawn from the power generator.

8. The method according to claim 1, wherein at least one of the threshold values has a predefined value that is not zero, between 0.1/s and 20/s, between 0.2/s and 10/s or between 0.5/s and 5/s.

9. The method according to claim 1, wherein at least one of the threshold values has a value that is not zero, which depends on the velocity of the object moved by the wheel and/or on the rotational speed of the rotor and/or wheel and is derived therefrom.

10. The method according to claim 1, wherein the rotational speed of the wheel and/or of the rotor is determined with:
a speed sensor that measures the rotational speed;
an acceleration sensor that measures the magnitude of the centrifugal acceleration or the frequency of the change in direction relative to gravity;
a magnetic field sensor that measures the frequency of the change in direction in relation to the earth's magnetic field or to a reference magnet;
an inductive sensor;
an ultrasonic sensor;
an optical sensor; and/or
an eccentrically aligned microphone to record tire noise of the wheel.

11. The method according to claim 1, wherein the rotational speed difference between the rotor and the stator is determined by:
determining a time interval between the zero crossings of the power generated by the rotor or at least one phase of the power; and/or
a speed sensor or a Hall-effect sensor that measures the differential rotational speed.

12. The method according to claim 1, wherein the power delivered by the power generator is controlled in a closed-loop manner via load control such that it remains below a predetermined limit value.

13. The method according to claim 12, wherein the limit value is prespecified such that, in the generator mode of the power generator, the stator is deflected from its vertical rest position into the operating position by less than 90° or less than 60°.

14. The method according to claim 12, wherein the method further comprises:
determining a characteristic rotational speed of a current velocity of the object moved by the wheel to thereby deduce a size of the current maximum electrical power that can be generated by the power generator without load control;
performing a check to see whether the determined characteristic rotational speed is greater than a switch-on threshold or a threshold determined by the user;
drawing, if the determined characteristic rotational speed is greater, an electrical load from the power generator;
determining the characteristic rotational speed again;
checking whether the further determined characteristic rotational speed is less than a switch-off threshold or a threshold defined by the user;
controlling, if the further determined characteristic rotation speed is not less, the generator load or the power delivered by the power generator using closed-loop control on the basis of the characteristic speed; and
switching off the generator load if the further determined characteristic rotation speed is greater.

15. The method according to claim 14, wherein the rotational speed of the wheel and/or of the rotor or the rotational speed difference between the rotor and the stator is determined as the characteristic rotational speed.

16. The method according to claim 14, wherein in the step, in which the generator load, or the power delivered by the power generator is controlled using closed-loop control via load control, load control is carried out according to a predetermined characteristic of the power generator and a predefined or programmed characteristic map is used in which the electrical power of the power generator in the generator mode is established on the basis of the characteristic variable or the velocity of the object moved by the wheel.

17. An electromagnetic power generator comprising:
a rotatably mounted stator having an eccentric center of mass and a rotor that is adapted to rotate relative to the stator, the power generator being adapted to be mounted on a wheel of an object that is movable via the wheel such that when the wheel rotates, the rotor rotates relative to the stator and the power generator thereby generates power in a generator mode;
electronics to detect whether the stator is overrunning, the electronics:
determine the rotational speed of the wheel and/or the rotor; determine the rotational speed difference between the rotor and the stator;
compare the rotational speed determined for the wheel and/or the rotor and the rotational speed difference determined between the rotor and the stator; and
detect whether the stator is overrunning in that it is determined whether the rotational speed determined for the wheel and/or the rotor deviates by more than a first threshold value or a user-defined threshold value from the rotational speed difference determined between the rotor and the stator; and
a controller to stop the stator from overrunning by supplying power to the rotor such that the stator is thereby accelerated.

18. The power generator according to claim 17, wherein the power generator comprises a housing to facilitate mounting on a wheel, the housing being insertable into a cylindrical cavity of the hub of the wheel and/or the housing being adapted to the wheel.

19. A wheel for a vehicle or a light-metal wheel, comprising:
a hub that has a cylindrical cavity; and
the electromagnetic power generator according to claim 17 arranged in the cylindrical cavity of the hub.
